(19) United States
(12) Patent Application Publication
(10) Pub. No.: US 2025/0253456 A1
(43) Pub. Date: Aug. 7, 2025

(54) BATTERY

(71) Applicants: Prime Planet Energy & Solutions, Inc., Tokyo (JP); TOYOTA JIDOSHA KABUSHIKI KAISHA, Aichi-ken (JP); TOYOTA BATTERY CO., LTD., Shizuoka-ken (JP)

(72) Inventors: Satoshi FUJIMURA, Toki-shi (JP); Yozo UCHIDA, Toyota-shi (JP); Yuki SATO, Toyota-shi (JP); Nozomi TATEYAMA, Okazaki-shi (JP); Masahiro UCHIMURA, Miyoshi-shi (JP); Masataka ASAI, Toyota-shi (JP); Keitaro MACHIDA, Hamamatsu-shi (JP); Takashi TAKIMOTO, Kosai-shi (JP); Shunsuke NAKAMURA, Hamamatsu-shi (JP); Shigeru MATSUMOTO, Toyohashi-shi (JP)

(21) Appl. No.: 18/991,726

(22) Filed: Dec. 23, 2024

(30) Foreign Application Priority Data
Feb. 6, 2024 (JP) 2024-016475

(51) Int. Cl. H01M 50/198; H01M 50/103; H01M 50/188; H01M 50/588

(52) U.S. Cl. CPC H01M 50/198; H01M 50/103; H01M 50/188; H01M 50/588

(57) ABSTRACT

A battery includes a case member, a terminal member, and a resin member. The case member has a through-hole. The resin member includes an inner portion that contacts an inner surface of the case member, an inside-hole portion that fills space between a wall of the through-hole and the terminal member, and an outer portion that contacts an outer surface of the case member and has a smaller volume than the inner portion. One of a first condition that the thermal expansion coefficient of the case member is larger than that of the inner portion and the tensile strength of the inner portion is lower than that of the outer portion and a second condition that the thermal expansion coefficient of the case member is smaller than that of the inner portion and the tensile strength of the outer portion is lower than that of the inner portion is satisfied.

### CROSS-REFERENCE TO RELATED APPLICATIONS

This application is based upon and claims the benefit of priority from the prior Japanese Patent Application No. 2024-016475 filed on Feb. 6, 2024, the entire contents of which are incorporated herein by reference.

### BACKGROUND

### Technical Field

The disclosed technology relates to a battery.

### Related Art

In a battery described in Japanese unexamined patent application publication No. 2021-86813 (JP 2021-86813 A), current collector terminals that extend through a case member are placed in position. The current collector terminals are connected to an electrode body. Terminal mounting holes through which the current collector terminals are passed are formed in the case member. An insulating material is embedded between the terminal mounting hole and the current collecting terminal. The insulating material is integrally molded with the case member and the current collector terminal.

### SUMMARY

### Technical Problems

The known battery of the related art had the problem of low durability against hot-cold cycles. This is because members made of materials, such as metal (case member, current collector terminals) and resin (insulating material), having different coefficients of thermal expansion adhere to each other.

The object of the disclosed technology is to provide a battery having excellent durability against hot-cold cycles.

### Means of Solving the Problems

A battery according to one aspect of the disclosed technology includes a case member that contains a power-generating element, a terminal member that is connected to the power-generating element and extends through the case member, and a resin member that insulates the case member and the terminal member from each other and provides a seal between the case member and the terminal member. The case member has a through-hole through which the terminal member is passed, and the resin member includes an inner portion that contacts an inner surface of the case member, an inside-hole portion that fills space between a wall of the through-hole and the terminal member, and an outer portion that contacts an outer surface of the case member and has a smaller volume than the inner portion. One of a first condition that a thermal expansion coefficient of the case member is larger than that of the inner portion and a tensile strength of the inner portion is lower than that of the outer portion and a second condition that the thermal expansion coefficient of the case member is smaller than that of the inner portion and the tensile strength of the outer portion is lower than that of the inner portion is satisfied.

In the battery according to the above aspect, portions of the case member provided with the terminal member and the resin member tend to be warped depending on the temperature. Where the first condition is satisfied, the case member tends to be warped to protrude inward when the temperature drops and protrude outward when the temperature rises. Where the second condition is satisfied, on the other hand, the case member tends to be warped to protrude outward when the temperature drops and protrude inward when the temperature rises. However, the portion of the resin member that expands when the temperature drops (the inner portion under the first condition, the outer portion under the second condition) has reduced tensile strength; therefore, cracking is less likely or unlikely to occur even when the temperature drops.

In the battery according to the above aspect, the resin member may include a filler, and the filler content in the inner portion may be lower than that in the outer portion when the first condition is satisfied, while the filler content in the inner portion may be higher than that in the outer portion when the second condition is satisfied. Alternatively, the resin member may include an elastomer, and the elastomer content in the inner portion may be higher than that in the outer portion when the first condition may be satisfied, while the elastomer content in the inner portion may be lower than that in the outer portion when the second condition is satisfied. In this way, the relationship between the tensile strengths of the inner portion and the outer portion can be satisfied. Also, the inner portion and the outer portion may have the same type of base resin.

In the battery of any of the forms described above, at least a part of an area of a surface of the case member that is covered with the resin member and an area of a surface of the terminal member that is covered with the resin member may be provided with a roughened surface area in which metal and resin penetrate each other. The anchor structure provided by the roughened surface area contributes to improvements in the adhesion between the case member and the resin member and the adhesion between the terminal member and the resin member. Furthermore, since the first condition or the second condition is satisfied, cracking is less likely or unlikely to occur.

According to the disclosed technology, the battery having excellent durability against hot-cold cycles is provided.

### BRIEF DESCRIPTION OF THE DRAWINGS

FIG. 1 is a perspective view of a battery according to one embodiment;

FIG. 2 is a front view of a terminal member;

FIG. 3 is a side view of the terminal member;

FIG. 4 is a perspective view of the terminal member;

FIG. 5 is a cross-sectional view of a terminal portion; and

FIG. 6 is a cross-sectional view showing only a resin member in FIG. 5.

### DETAILED DESCRIPTION OF THE EXEMPLARY EMBODIMENTS

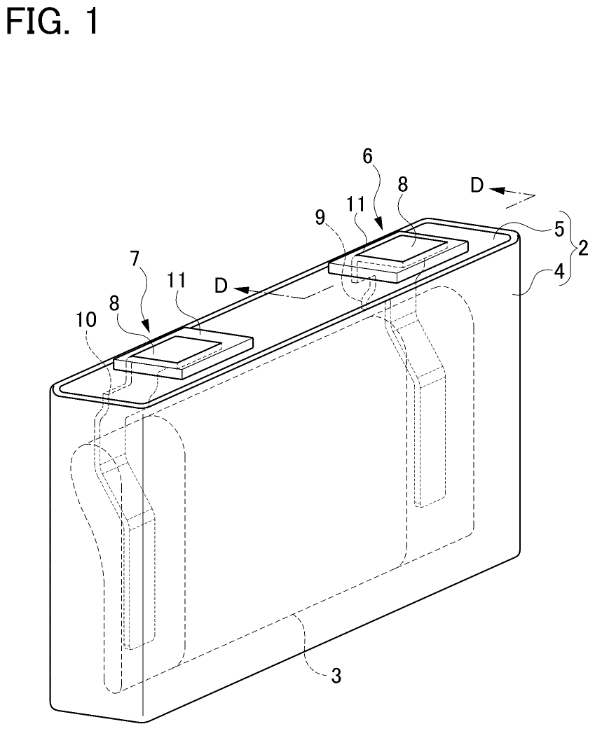

FIG. 1 shows a battery 1 according to one embodiment of the disclosed technology. The battery 1 has a power-generating element 3 incorporated in a case member 2. The case member 2 consists of a box 4 and a lid 5. The box 4 is a box-shaped member that contains the power-generating element 3 and has an open top. The lid 5 is a plate-shaped member that closes the opening of the box 4. Both the box 4 and the lid 5 are part of the case member 2. The power-generating element 3 is an electrode stacked body formed by stacking positive and negative electrode plates along with an electrolyte.

Positive and negative terminal portions 6, 7 are provided near both ends of the lid 5 in the longitudinal direction. Terminal surfaces 8 are exposed at both of the terminal portions 6, 7. The terminal surfaces 8 are part of surfaces of terminal members 9, 10 that will be described later. The terminal members 9, 10 are insulated from the lid 5 by resin members 11. The resin members 11 also serve to provide seals between the terminal member 9 and the lid 5 and between the terminal member 10 and the lid 5.

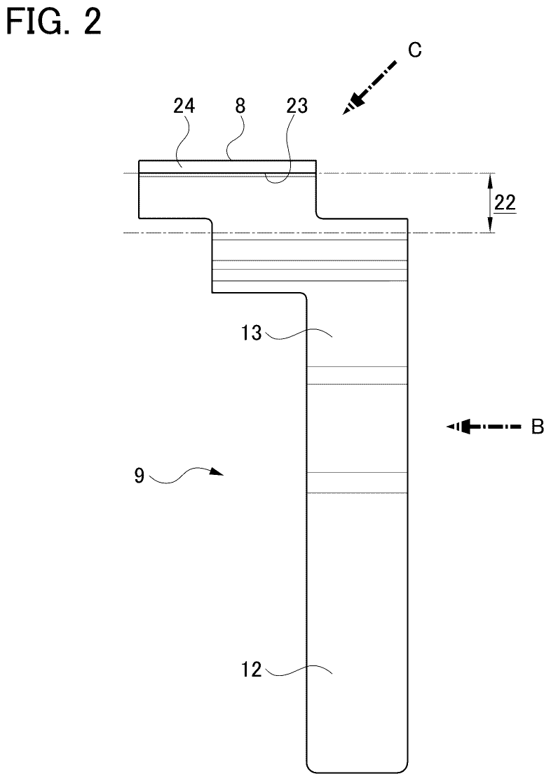

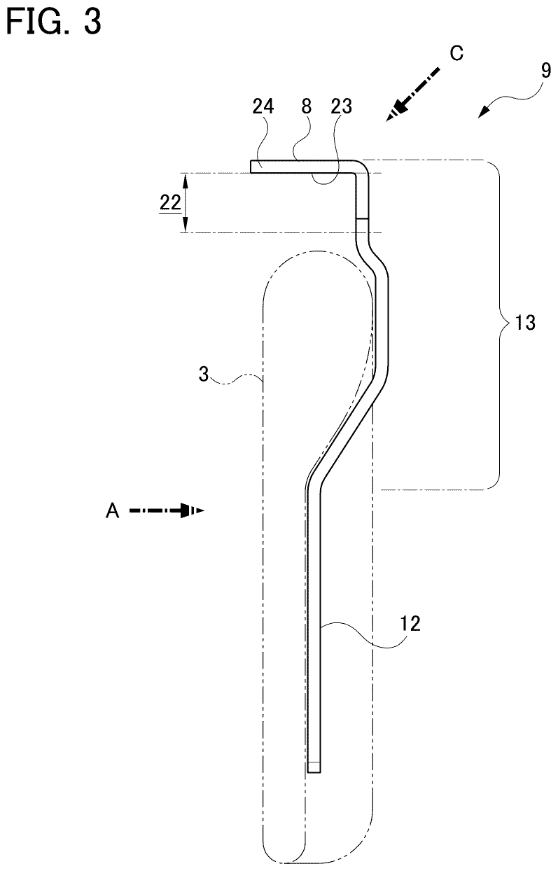

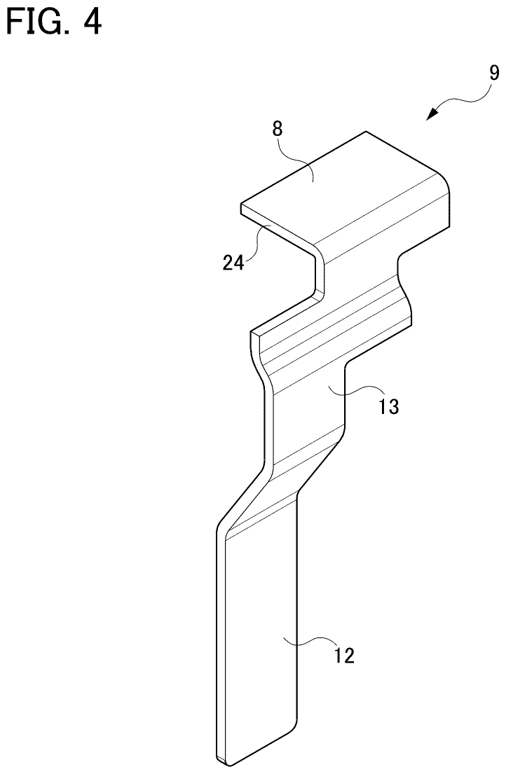

The terminal member 9 will be described. FIG. 2 to FIG. 4 show the terminal member 9 alone. FIG. 2 is a front view of the terminal member 9 as seen in the direction of arrow A in FIG. 3. FIG. 3 is a side view of the terminal member 9 as seen in the direction of arrow B in FIG. 2. FIG. 3 shows a part of the power-generating element 3 with a broken line, in addition to the terminal member 9. FIG. 4 is a perspective view of the terminal member 9 as seen in the direction of arrow C in FIG. 2 and FIG. 3. The terminal member 9 is a conductive member connected to the power-generating element 3 in the case member 2. The terminal member 9 extends through the lid 5.

The terminal member 9 has an exposed portion 24, a connecting portion 12, and an intermediate portion 13. The terminal member 9 is connected at the exposed portion 24 to an external conductor. The terminal surface 8 shown in FIG. 1 is an outer surface of the exposed portion 24 that faces outward. The connecting portion 12 is connected to one of the electrode plates of the power-generating element 3. The intermediate portion 13 connects the exposed portion 24 and the connecting portion 12.

The terminal member 10 is a conductive member with a shape of the terminal member 9 reversed in the left-right direction. The terminal member 9 and the terminal member 10 are normally made of different metals. For example, aluminum is used for one of the terminal members 9, 10 for the positive electrode, and copper is used for the other terminal member for the negative electrode.

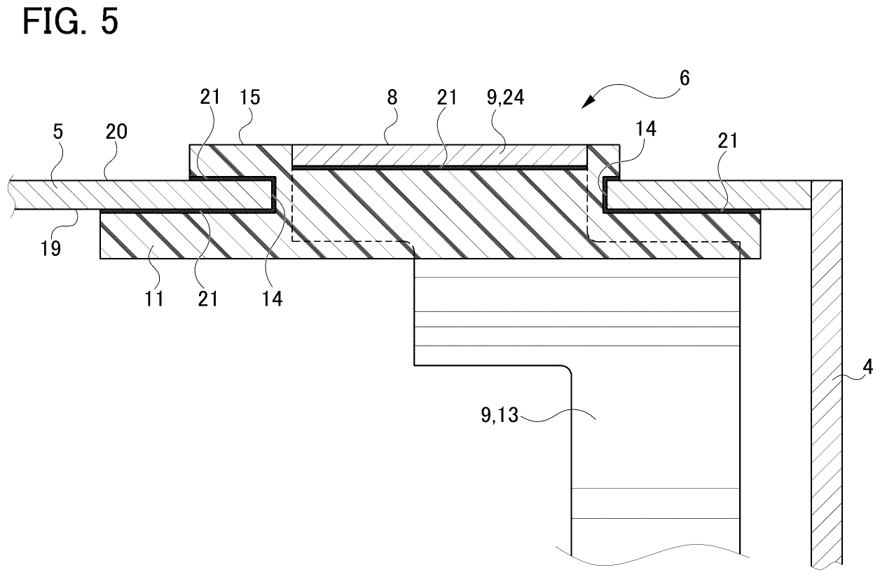

The terminal portion 6 will be described. FIG. 5 is a cross-sectional view of a part of the terminal portion 6 of the lid 5. FIG. 5 shows a vertical section parallel to the longitudinal direction of the lid 5, as indicated by arrows D, D in FIG. 1. The vertical section of FIG. 5 is taken along the middle of the lid 5 as viewed in the width direction. As shown in FIG. 5, a through-hole 14 is formed in the lid 5. The through-hole 14 is shaped so that the terminal member 9 is passed through the through-hole 14.

The lid 5 and the terminal member 9 are not in contact with each other. The above-mentioned resin member 11 is provided between the lid 5 and the terminal member 9. The presence of the resin member 11 prevents the lid 5 and the terminal member 9 from contacting each other. The resin member 11 also fills the through-hole 14. The resin member 11 blocks off the space inside the case member 2 from the space outside. The resin member 11 is molded in a condition where the terminal member 9 is positioned relative to the lid 5. The lid 5 and the terminal member 9 are integrated by the resin member 11. In this embodiment, the terminal surface 8 is substantially flush with an outer surface 15 of the resin member 11.

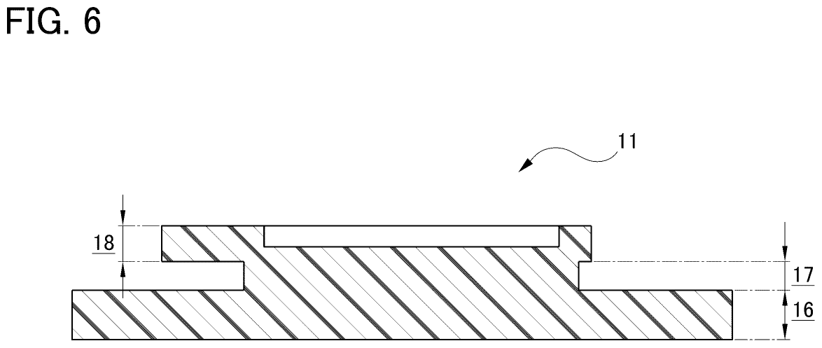

The resin member 11 includes an inner portion 16, an inside-hole portion 17, and an outer portion 18, as shown in FIG. 6. The inner portion 16 is a portion of the resin member 11 located below the lid 5 in FIG. 5. The inside-hole portion 17 is a portion of the resin member 11 within the thickness of the lid 5 in FIG. 5. The outer portion 18 is a portion of the resin member 11 located above the lid 5. Specifically, the inner portion 16 contacts an inner surface 19 of the lid 5. The inside-hole portion 17 fills space between the wall of the through-hole 14 and the terminal member 9. The outer portion 18 contacts an outer surface 20 of the lid 5. FIG. 6 shows only the resin member 11 for the sake of explanation. In reality, the resin member 11 having the shape shown in FIG. 6 does not exist as a single or independent component.

The volume of the outer portion 18 is smaller than that of the inner portion 16. This is because the height of the outer portion 18 and the terminal surface 8 as measured from the outer surface 20 cannot be made too large, for the sake of connection between the battery 1 and an external circuit. This means that, in connection with the expansion and contraction of the resin member 11 relative to the lid 5 in the event of a temperature change, the inner portion 16 with the larger volume becomes a more dominant factor than the outer portion 18.

In the battery 1, the relationship between the thermal expansion coefficient of the lid 5 and that of the inner portion 16 and the relationship between the tensile strength of the inner portion 16 and that of the outer portion 18 are determined so as to satisfy a special relationship. The special relationship is selected from two conditions, i.e., a first condition and a second condition, and either one of the conditions is satisfied.

The contents of the first condition and the second condition are as follows. First condition: the thermal expansion coefficient of the lid 5 is larger than that of the inner portion 16, and the tensile strength of the inner portion 16 is lower than that of the outer portion 18.

Second condition: the thermal expansion coefficient of the lid 5 is smaller than that of the inner portion 16, and the tensile strength of the outer portion 18 is lower than that of the inner portion 16.

The first condition will be described. Under the first condition, the expansion and contraction of the lid 5 are more noticeable than those of the inner portion 16 in response to temperature changes, based on the above relationship between the thermal expansion coefficients. Thus, the lid 5 shown in FIG. lid 5 tends to be warped to protrude downward when the temperature drops and tends to be warped to protrude upward when the temperature rises.

When the temperature drops, the inner portion 16 is also warped to protrude downward. This is because the upper surface of the inner portion 16 is pulled due to contraction of the lid 5 and contracts more strongly than it would normally. On the other hand, tensile stress is applied to the lower surface of the inner portion 16 on the stretching side. The tensile stress is a factor that would cause the inner portion 16 to crack, peel off from the terminal member 9, and peel off from the lid 5. However, under the first condition, the inner portion 16 has high flexibility and thus does not actually crack or peel off even when the temperature drops.

Conversely, when the temperature rises, the outer portion 18 becomes the stretching side, and tensile stress is applied to the upper surface of the outer portion 18. However, when the temperature rises, the resin softens to some extent due to the high temperature. Therefore, the outer portion 18 becomes somewhat flexible, and cracking, etc. do not occur in the outer portion 18 when the temperature rises.

The second condition will be described. Under the second condition, the expansion and contraction of the inner portion 16 are more noticeable than those of the lid 5 in response to temperature changes, based on the above relationship between the thermal expansion coefficients. Thus, contrary to the case of the first condition, the lid 5 tends to be warped to protrude upward when the temperature drops and tends to be warped to protrude downward when the temperature rises.

When the temperature drops, the outer portion 18 is also warped to protrude upward. This is because the lower surface of the outer portion 18 is pulled due to the contraction of the lid 5 and contracts more strongly than it would normally. On the other hand, tensile stress is applied to the upper surface of the outer portion 18. The tensile stress is a factor that would cause the outer portion 18 to crack or peel off. However, under the second condition, the outer portion 18 has high flexibility and thus does not actually crack or peel off even when the temperature drops.

Conversely, when the temperature rises, tensile stress is applied to the lower surface of the inner portion 16. However, when the temperature rises, the resin of the inner portion 16 softens to some extent due to the high temperature. Therefore, cracking, etc. do not occur in the inner portion 16 when the temperature rises.

As described above, in the battery 1 of this embodiment, when either one of the first condition and the second condition is satisfied, cracking and peel-off are less likely or unlikely to occur in the resin member 11 even when the temperature drops or rises. Thus, the battery 1 has excellent durability against hot-cold cycles.

As described above, in the resin member 11 according to the embodiment, the inner portion 16 and the outer portion 18 have different properties. At least the tensile strength differs between the inner portion 16 and the outer portion 18. The thermal expansion coefficient may also differ between the inner portion 16 and the outer portion 18. The different properties may be imparted to the inner portion 16 and the outer portion 18 by three methods, i.e., (1) a method using a composite resin including a filler as the resin member 11 and varying the compounding ratio of the filler, (2) a method using a composite resin including an elastomer and varying the compounding ratio of the elastomer, and (3) a method using base resins of different resin types.

The method using the filler will be described. The filler consists of minute solids. For example, glass fibers, glass powder, etc. may be used as the filler. When the base resin is the same, the tensile strength of the composite resin is higher as the compounding ratio of the filler is higher. Accordingly, the outer portion 18 has the higher compounding ratio of the filler than the inner portion 16 when the first condition is satisfied, and the inner portion 16 has the higher compounding ratio of the filler than the outer portion 18 when the second condition is satisfied.

When the base resin is the same, the thermal expansion coefficient of the composite resin is smaller as the compounding ratio of the filler is higher. When the base resin of the resin member 11 is, for example, PPS resin, and the material of the lid 5 is, for example, aluminum, the thermal expansion coefficient of the base resin is almost twice as large as that of the lid 5.

To satisfy the first condition, the compounding ratio of the filler in the inner portion 16 is increased to the extent that the thermal expansion coefficient of the inner portion 16 as the composite resin is smaller than that of aluminum. Under the first condition, the compounding ratio of the filler in the outer portion 18 is even higher than that in the inner portion 16. To satisfy the second condition, the compounding ratio of the filler in the inner portion 16 is kept to a level where the thermal expansion coefficient of the inner portion 16 as the composite resin does not fall below that of aluminum. Under the second condition, the compounding ratio of the filler in the outer portion 18 is even lower than that in the inner portion 16. In the method using the filler, the compounding ratio of the filler is controlled in the manner as described above so that the first condition or the second condition is satisfied.

The method using the elastomer will be described. The elastomer is a polymer material with a low modulus of elasticity and viscoelasticity. When the base resin is the same, the tensile strength of the composite resin is higher as the compounding ratio of the elastomer is lower. Accordingly, the compounding ratio of the elastomer in the inner portion 16 is higher than that in the outer portion 18 under the first condition, and the compounding ratio of the elastomer in the outer portion 18 is higher than that in the inner portion 16 under the second condition.

When the base resin is the same, the thermal expansion coefficient of the composite resin is smaller as the compounding ratio of the elastomer is lower. To satisfy the first condition, the compounding ratio of the elastomer in the inner portion 16 is kept to a level where the thermal expansion coefficient of the inner portion 16 as the composite resin falls below that of aluminum. Under the first condition, the compounding ratio of the elastomer in the outer portion 18 is even lower than that in the inner portion 16. To satisfy the second condition, the compounding ratio of the elastomer in the inner portion 16 is increased to the extent that the thermal expansion coefficient of the inner portion 16 as the composite resin does not fall below that of aluminum. Under the second condition, the compounding ratio of the elastomer in the outer portion 18 is even higher than that in the inner portion 16. In the method using the elastomer, the compounding ratio of the elastomer is controlled in the manner as described above so that the first condition or the second condition is satisfied.

The method using the base resins of different resin types will be described. There are various types of, for example, PPS resin, depending on various factors, such as the molecular weight and the degree of cross-linking. A resin type of the inner portion 16 and another resin type of the outer portion 18 may be selected so that the first condition or the second condition is satisfied.

While the inside-hole portion 17 has not been referred to in the above description of the resin member 11, the properties of the inside-hole portion 17 may be the same as those of either one of the inner portion 16 and the outer portion 18. Alternatively, the inside-hole portion 17 may have a portion having the same properties as the inner portion 16 and a portion having the same properties as the outer portion 18, and the boundary between these portions may be located at the middle of the inside-hole portion 17.

The resin member 11 having the portions of two resin types with different properties is molded using two types of resin materials. In a condition where the terminal member 9 is positioned relative to the through-hole 14 of the lid 5 and held, the resin material of the inner portion 16 is supplied from below to form the inner portion 16 or form the inner portion 16 and the inside-hole portion 17. Then, the resin material of the outer portion 18 is supplied from above to form the outer portion 18 or form the outer portion 18 and the inside-hole portion 17. The filler or elastomer is blended into the base resin in advance when the composite resin is used.

When the base resins of the inner portion 16 and the outer portion 18 are of the same type or have a high affinity, a mixed layer may be formed at the position of contact between the two resin types, depending on the molding conditions. In this case, peel-off is less likely or unlikely to occur at the interface of the two resin types in subsequent hot-cold cycles.

Next, the anchor structure of the terminal portion 6 will be described. In the terminal portion 6 of the battery 1 of this embodiment, anchor structure regions are provided at joint surfaces between metal parts (the lid 5 and the terminal member 9) and the resin member 11. The anchor structure regions are provided in the ranges of surfaces of the metal parts that are covered with the resin member 11. The anchor structure regions are roughened surface areas where the metal and the resin penetrate each other. In FIG. 5, those of the anchor structure regions appearing on the cross-sectional view are indicated by thick lines 21.

In the anchor structure region, the metal part and the resin member 11 engage with each other. Thus, in the anchor structure region, the metal part and the resin member 11 have good adhesion and are unlikely to peel off. On the other hand, this is likely to cause cracking of the resin member 11 in a situation where the lid 5 tends to be warped when the temperature drops or rises. The cracking is likely to occur in one of the inner portion 16 and the outer portion 18 of the resin member 11 to which tensile stress is applied. With the anchor structure region thus provided, the tensile stress is not relieved due to peel-off of the metal part and the resin member 11, so cracking is likely to occur. However, in the resin member 11 of this embodiment, the properties of the inner portion 16 and outer portion 18 are properly set so as to satisfy the first condition or the second condition. Thus, cracking is less likely or unlikely to occur even though the anchor structure regions are provided.

The portions of the lid 5 and the terminal member 9 that are to be provided with the anchor structure regions are subjected in advance to a roughening treatment. Minute protrusions and recesses with a size of several tens to several hundreds of nanometers (nm) are formed in the range subjected to the roughening treatment. During molding of the resin member 11, the resin material flows into the recesses of the protrusions and recesses on the roughened surfaces, to provide the anchor structure regions.

FIG. 2 and FIG. 3 show a roughened surface area 22 as a range in the terminal member 9 that is subjected to the roughening treatment. The roughened surface area 22 extends from the level of the lower surface 23 of the exposed portion 24 of the terminal member 9 to around the middle of the intermediate portion 13. The lower surface 23 is also subjected to the roughening treatment. The terminal surface 8 is not subjected to the roughening treatment. It is not necessary to strictly determine the lower limit of the roughened surface area 22. There is no problem even if the roughened surface area 22 extends below the range in which the terminal member 9 is to contact with the resin member 11.

While the resin member 11 of the terminal portion 6 has been described above, the resin member 11 of the terminal portion 7 is similar to that of the terminal portion 6. The terminal portion 7 may also be provided with anchor structure regions. The roughened surface area in the terminal member 10 for the anchor structure regions is not significantly different from those shown in FIG. 2 and FIG. 3.

As described above in detail, according to this embodiment, the resin members 11 between the lid 5 and the terminal members 9, 10 extending through the lid 5 satisfy the first condition or the second condition. As a result, cracking of the resin members 11 is prevented. In particular, cracking is less likely or unlikely to occur even in an area that is prone to cracking, such as an area where the resin expands when the temperature drops. Thus, the battery 1 having excellent durability against hot-cold cycles has been achieved.

This embodiment and examples are merely exemplary and are not intended to limit the disclosed technology. Accordingly, the disclosed technology can be improved or modified in various ways without departing from its principle. For example, the battery type of the battery 1 is not limited. The battery 1 may be a lithium-ion battery, nickel-metal-hydride battery, a solid-state battery, or any other type of battery. In the battery 1, the disclosed technology may be applied to both the positive and negative terminal portions 6, 7, or only one of the terminal portions 6, 7.

As the resin material that forms the resin member 11, a composite resin with a filler and an elastomer both blended into a base resin may be used. The resin type of the base resin of the resin member 11 may be selected from those other than PPS resin. The material of the lid 5 may be a metal other than aluminum. The range of the anchor structure regions in the terminal members 9, 10 and the lid 5 is not necessarily the entire area of contact with the resin of the resin members 11, but may be a part of the contact area.

### REFERENCE SIGNS LIST

1 Battery
2 Case member
3 Power-generating element
4 Box
5 Lid
8 Terminal surface
9 Terminal member
10 Terminal member
11 Resin member
12 Connecting portion
13 Intermediate portion
14 Through-hole
16 Inner portion
17 Inside-hole portion
18 Outer portion
21 Thick line
22 Roughened surface area
24 Exposed portion

What is claimed is:

1. A battery comprising:
a case member that contains a power-generating element;
a terminal member that is connected to the power-generating element and extends through the case member; and
a resin member that insulates the case member and the terminal member from each other and provides a seal between the case member and the terminal member,
wherein the case member has a through-hole through which the terminal member is passed,
wherein the resin member includes an inner portion that contacts an inner surface of the case member, an inside-hole portion that fills space between a wall of the through-hole and the terminal member, and an outer portion that contacts an outer surface of the case member and has a smaller volume than the inner portion, and
wherein one of a first condition that a thermal expansion coefficient of the case member is larger than that of the inner portion and a tensile strength of the inner portion is lower than that of the outer portion and a second condition that the thermal expansion coefficient of the case member is smaller than that of the inner portion and the tensile strength of the outer portion is lower than that of the inner portion is satisfied.

2. The battery according to claim 1, wherein:
the resin member includes a filler;
a content of the filler in the inner portion is lower than that in the outer portion when the first condition is satisfied; and
the content of the filler in the inner portion is higher than that in the outer portion when the second condition is satisfied.

3. The battery according to claim 1, wherein:
the resin member includes an elastomer;
an content of the elastomer in the inner portion is higher than that in the outer portion when the first condition is satisfied; and
the content of the elastomer in the inner portion is lower than that in the outer portion when the second condition is satisfied.

4. The battery according to claim 2, wherein the inner portion and the outer portion have the same type of base resin.

5. The battery according to claim 1, wherein at least a part of an area of a surface of the case member that is covered with the resin member and an area of a surface of the terminal member that is covered with the resin member is provided with a roughened surface area in which metal and resin penetrate each other.

6. The battery according to claim 3, wherein the inner portion and the outer portion have the same type of base resin.

7. The battery according to claim 2, wherein at least a part of an area of a surface of the case member that is covered with the resin member and an area of a surface of the terminal member that is covered with the resin member is provided with a roughened surface area in which metal and resin penetrate each other.

8. The battery according to claim 3, wherein at least a part of an area of a surface of the case member that is covered with the resin member and an area of a surface of the terminal member that is covered with the resin member is provided with a roughened surface area in which metal and resin penetrate each other.
